(19) United States
(12) Patent Application Publication
(10) Pub. No.: US 2026/0139202 A1
(43) Pub. Date: May 21, 2026

(54) POLYESTERS

(71) Applicant: Clariant International Ltd, Muttenz (CH)

(72) Inventors: Hiroe YAMADA, Frankfurt am Main (DE); Clemens LIEDEL, Frankfurt am Main (DE); Carsten SCHAEFER, Frankfurt am Main (DE); Silke QUESTER, Frankfurt am Main (DE); Sidonie VOLLRATH, Frankfurt am Main (DE); Gang SI, Longbenton, Newcastle upon Tyne (GB); Michael MCDONNEL, Longbenton, Newcastle upon Tyne (GB); Ming FAN, Cincinnati, OH (US)

(73) Assignee: Clariant International Ltd, Muttenz (CH)

(21) Appl. No.: 19/121,849

(22) PCT Filed: Nov. 2, 2023
(86) PCT No.: PCT/EP2023/080528

§ 371 Date: Apr. 17, 2025

(30) Foreign Application Priority Data
Nov. 4, 2022 (EP) 22205454.6

(51) Int. Cl. C11D 3/37; C08G 63/688; C08G 63/78; C11D 3/00; C11D 3/43

(52) U.S. Cl. CPC C11D 3/3715; C08G 63/6886; C08G 63/78; C11D 3/0036; C11D 3/43

(57) ABSTRACT

Specific anionic polyesters are described which are particularly suitable for use in fabric and home care compositions such as laundry detergent compositions. In such applications, the polyesters e. g. exhibit advantageous whiteness maintenance and soil release performance and have advantageous biodegradability.

The present invention relates to specific anionic polyesters, a process for the preparation of such polyesters and solutions or dispersions comprising such polyesters. The polyesters may be applied in fabric and home care compositions, preferably in laundry detergent compositions, e. g. as soil release polymers.

Soil release polymers are known and used in fabric and home care formulations. In the washing process, soil release polymers can deposit on fibers, which changes the surface properties of the fabric and in particular delivers the benefit of easier soil removal from fabrics which have been treated with a soil release polymer in a previous washing process.

Anionic soil release polymers typically have poor biodegradability, which limits their application in green and sustainable fabric and home care formulations such as laundry detergent compositions.

It was an object of the present invention to provide substances which show advantageous performance in laundry detergent compositions, preferably advantageous washing performance in laundry detergent compositions, and possess advantageous biodegradability.

Surprisingly, this object may be solved by polyesters comprising
A) one or more structural units of the formula (I)

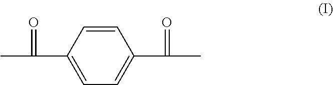

and
B) one or more structural units of the formula (II)

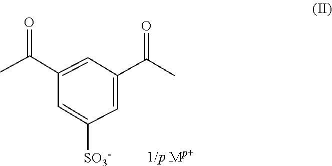

wherein
1/p M^{p+} is a cation, preferably selected from the group consisting of monovalent cations M⁺ (p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H,
   and
C) one or more structural units of the formula (III)

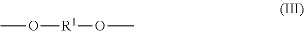

wherein
R¹ is a linear or branched alkylene group represented by the formula (CₘH₂ₘ) wherein m is an integer from 2 to 12, preferably from 2 to 6, more preferably from 2 to 4 and even more preferably from 2 to 3,
   and
D) one or more terminal groups of the formula (IV)

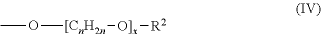

wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CHs,
n is 2 or an integer >2, preferably is an integer from 2 to 12, more preferably is an integer from 2 to 6 and even more preferably is an integer from 2 to 4, whereby the definition of n may vary within a single terminal group of the formula (IV), and
x is, based on molar average, a number of at least 55, preferably from 55 to 200, more preferably from 55 to 180, even more preferably from 55 to 150, particularly preferably from 60 to 120 and extraordinarily preferably from 65 to 115.

Therefore, a subject matter of the present invention is polyesters comprising
A) one or more structural units of the formula (I)

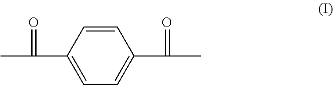

and
B) one or more structural units of the formula (II)

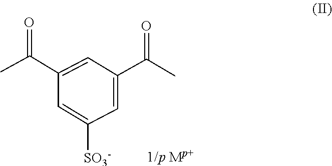

wherein
1/p M^{p+} is a cation, preferably selected from the group consisting of monovalent cations M⁺ (p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H,
   and
C) one or more structural units of the formula (III)

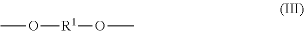

wherein
R¹ is a linear or branched alkylene group represented by the formula (CₘH₂ₘ) wherein m is an integer from 2 to 12, preferably from 2 to 6, more preferably from 2 to 4 and even more preferably from 2 to 3,
   and
D) one or more terminal groups of the formula (IV)

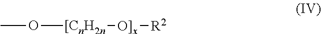

wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
n is 2 or an integer >2, preferably is an integer from 2 to 12, more preferably is an integer from 2 to 6 and even more preferably is an integer from 2 to 4, whereby the definition of n may vary within a single terminal group of the formula (IV), and
x is, based on molar average, a number of at least 55, preferably from 55 to 200, more preferably from 55 to 180, even more preferably from 55 to 150, particularly preferably from 60 to 120 and extraordinarily preferably from 65 to 115.

U.S. Pat. No. 4,702,857 A discloses block polyesters useful as soil release agents in detergent compositions.

WO 2007/079850 A1 discloses anionic soil release polyesters comprising terephthalic acid, sulfoisophthalic acid-(poly)alkylene glycol, a non-ionic terminal group and optionally a multi-functional cross-linked monomer. Said polyesters are suitable as soil release components in washing and cleaning agents.

US 2022/0186144 A1 discloses a unit dose detergent product that includes a unit dose pouch with a water soluble film, and a liquid detergent encapsulated in the unit dose pouch. The liquid detergent includes a soil release polymer, at least 10% by weight of an alkyl-ether sulfate, an alkoxylated polyamine, less than 30% by weight of water, and, optionally, a polyglycol. A mixture of 2 parts of the liquid detergent composition to 1 part water has a viscosity below 3,000 centipoise.

US 2004/024101 A1 relates to copolyether esters and more particularly, to sulfonated aliphatic-aromatic copolyetheresters that have advantageous thermal properties and are biodegradable.

US 2005/171250 A1 describes sulfonated aliphatic-aromatic copolyesters, wherein the acid component comprises 32-56% mol of sebacic acid, based on 100% mol of the total acid component. The sulfonated aliphatic-aromatic polyesters have improved biodegradability.

WO 2010/071771 A1 describes a polymerization process in which dimers of diols are formed and incorporated into polyesters during polycondensation. Control over this phenomenon provides unique polymer compositions with a range of thermo-mechanical properties, crystallinity, bio-content and biodegradability.

The one or more structural units of the formula (I) of the polyesters of the invention preferably are derived from terephthalic acid and/or a derivative thereof. Herein, the term “derivative thereof” comprises, but is not limited to, salts thereof, esters thereof, anhydrides thereof, and any mixtures of the foregoing.

Preferably, the one or more structural units of the formula (I) of the polyesters of the invention are derived from terephthalic acid or its dialkyl esters, preferably its (C₁-C₄)-dialkyl esters and more preferably its dimethyl ester.

In the case that one molecule of the polyesters of the invention comprises two or more of the structural units of the formula (II), the definition of 1/p M^{p+} may vary between those structural units.

The one or more structural units of the formula (II) of the polyesters of the invention preferably are derived from 5-sulfoisophthalic acid and/or a derivative thereof. Herein, the term “derivative thereof” comprises, but is not limited to, salts thereof, esters thereof, anhydrides thereof, and any mixtures of the foregoing.

Among “5-sulfoisophthalic acid and/or a derivative thereof” 5-sulfoisophthalic acid sodium salt and dimethyl-5-sulfoisophthalate sodium salt (5-SIM) are preferred.

The amount of the one or more structural units of the formula (II) in the polyesters of the invention is, on average, preferably from 1 to 80 mol-%, more preferably from 2 to 60 mol-%, even more preferably from 5 to 50 mol-%, particularly preferably from 10 to 40 mol-%, and extraordinarily preferably from 15 to 30 mol-%, in each case based on the combined amount of the one or more structural units of the formula (I) and the one or more structural units of the formula (II) in the polyesters of the invention.

Preferably, the total number of the one or more structural units of the formula (I) and the one or more structural units of the formula (II) in the polyesters of the invention is, based on molar average, from 2 to 30, more preferably from 3 to 22, even more preferably from 5 to 16 and particularly preferably from 6 to 14.

In the case that one molecule of the polyesters of the invention comprises two or more of the structural units of the formula (III), the definition of R¹ may vary between those structural units.

The one or more structural units of the formula (III) preferably are derived from alkylene glycol of the formula HO—R¹—OH wherein R¹ has the meaning given above for formula (III). Preferably, the alkylene glycol is selected from C₂-C₁₂ alkylene glycol, more preferably from C₂-C₆ alkylene glycol, even more preferably from C₂-C₄ alkylene glycol and particularly preferably from C₂-C₃ alkylene glycol.

When the alkylene glycol contains three or more carbon atoms, it is the intention of the invention to cover all possible isomers of the alkylene glycol. For example, when the alkylene glycol contains three carbon atoms, it can include HO—CH₂—CH₂—CH₂—OH, HO—CH₂—CH(CH₃)—OH, and when the alkylene glycol contains 4 carbon atoms, it can include HO—CH₂—CH₂—CH₂—CH₂—OH, HO—CH₂—CH₂—CH(CH₃)—OH, HO—CH₂—CH(CH₃)—CH₂—OH, and HO—CH(CH₃)—CH(CH₃)—OH.

When the alkylene glycol contains three or more carbon atoms, it is also the intention of the invention to cover all possible ways in which the alkylene glycol may connect with other structural units of the polyester of the invention. For example, when the alkylene glycol is HO—CH₂—CH(CH₃)—OH, the monomer has two possible ways to connect with other structural units of the polyester of the invention: —O—CH₂—CH(CH₃)—O— or —O—CH(CH₃)—CH₂—O—.

Among C₂-C₄ alkylene glycol ethylene glycol, 1,3-propylene glycol, 1,2-propylene glycol, 1,4-butylene glycol, 1,3-butylene glycol, 2,3-butylene glycol and mixtures thereof are preferred.

Preferably, the polyester of the invention comprises one or more structural units of the formula (III) wherein m is 3.

More preferably, the polyester of the invention comprises one or more structural units of the formula (III) wherein m is 2 and one or more structural units of the formula (III) wherein m is 3.

The one or more structural units of the formula (III) wherein m is 2, preferably are derived from ethylene glycol.

The one or more structural units of the formula (III) wherein m is 3, preferably are derived from 1,2-propylene glycol.

Even more preferably, the one or more structural units of the formula (III) are selected from the group consisting of structural units derived from ethylene glycol, structural units derived from 1,2-propylene glycol and structural units derived from mixtures of ethylene glycol and 1,2-propylene glycol, particularly preferably, the one or more structural units of the formula (III) are selected from the group consisting of structural units derived from 1,2-propylene glycol and structural units derived from mixtures of ethylene glycol and 1,2-propylene glycol, and extraordinarily preferably, the one or more structural units of the formula (III) are structural units derived from mixtures of ethylene glycol and 1,2-propylene glycol.

In the following, specific examples of structural units of the formula (III) derived from alkylene glycol are given. The structural units of the formula (III) derived from 1,2-propylene glycol have the formula (III-1)

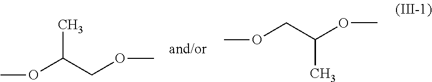

and the structural units of the formula (III) derived from ethylene glycol have the formula (III-2)

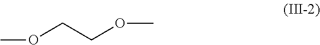

In case the polyesters of the invention comprise one or more structural units of the formula (III-1) and one or more structural units of the formula (III-2), the amount of the one or more structural units of the formula (III-1) in the polyesters of the invention is, on average, preferably from 1 to 100 mol-%, more preferably from 10 to 90 mol-%, even more preferably from 20 to 80 mol-%, particularly preferably from 30 to 70 mol-%, and extraordinarily preferably from 40 to 60 mol-%, in each case based on the combined amount of the one or more structural units of the formula (III-1) and the one or more structural units of the formula (III-2) in the polyesters of the invention.

In the case that one molecule of the polyesters of the invention comprises two or more of the terminal groups of the formula (IV), the definitions of n, x and R² may vary between those terminal groups.

The one or more terminal groups of the formula (IV) preferably are derived from substances of the formula HO—[CₙH₂ₙ—O]ₓ—R², wherein n, x and R² have the meanings given above for formula (IV).

Preferably, x in the one or more terminal groups of the formula (IV) is, based on molar average, a number of at least 56, more preferably from 56 to 200, even more preferably from 59 to 180, particularly preferably from 62 to 150, extraordinarily preferably from 65 to 120 and especially preferably from 67 to 115.

Preferably, n in the one or more terminal groups of the formula (IV) is 2.

Preferably, the one or more terminal groups of the formula (IV) of the polyester of the invention are selected from the formula (IV-a)

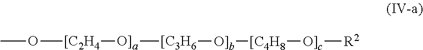

wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
a, b and c are, based on molar average, independently of one another, numbers from 0 to 200, the sum of a+b+c is a number of at least 55, preferably from 55 to 200, more preferably from 55 to 180, even more preferably from 55 to 150, particularly preferably from 60 to 120 and extraordinarily preferably from 65 to 115, the [C₂H₄—O], [C₃H₆—O] and/or [C₄H₈—O]units of the one or more terminal groups of the formula (IV-a) may be arranged blockwise, alternating, periodically and/or statistically, preferably blockwise and/or statistically, and either of the [C₂H₄—O], [C₃H₆—O] and [C₄H₈—O]units of the one or more terminal groups of the formula (IV-a) can be linked to —R² and/or —O.

Any of the units [C₄H₈₋₀], [C₃H₆—O] and [C₂H₄—O]can be linked to R²— and —O. This means, for example, that both R²— and —O may be connected to a [C₄H₈—O]— group, they may both be connected to a [C₃H₆—O]— group, they may both be connected to a [C₂H₄—O]— group or they may be connected to different groups selected from [C₄H₈—O], [C₃H₆—O] and [C₂H₄—O].

In the case that one molecule of the polyesters of the invention comprises two or more of the terminal groups of the formula (IV-a), the definitions of R², a, b and c, and the sum of a+b+c may vary between those terminal groups.

The one or more terminal groups of the formula (IV-a) preferably are derived from substances of the formula HO—[C₂H₄—O]ₐ—[C₃H₆—O]_{b}—[C₄H₈—O]_{c}—R², wherein R², a, b and c, and the sum of a+b+c have the meanings given above for formula (IV-a).

In the one or more terminal groups of the formula (IV-a) the sum of a+b+c preferably is a number of at least 56, more preferably from 56 to 200, even more preferably from 59 to 180, particularly preferably from 62 to 150, extraordinarily preferably from 65 to 120 and especially preferably from 67 to 115.

In a preferred embodiment of the invention, “a” in the one or more terminal groups of the formula (IV-a) is, based on molar average, a number from 45 to 200 and more preferably from 50 to 180.

Preferably, “a” in the one or more terminal groups of the formula (IV-a) is, based on molar average, a number from 55 to 200, more preferably from 55 to 180, even more preferably from 55 to 150, particularly preferably from 60 to 120 and extraordinarily preferably from 65 to 115.

More preferably, “a” in the one or more terminal groups of the formula (IV-a) is, based on molar average, a number from 56 to 200, even more preferably from 59 to 180, particularly preferably from 62 to 150, extraordinarily preferably from 65 to 120 and especially preferably from 67 to 115.

Preferably, “b” in the one or more terminal groups of the formula (IV-a) is, based on molar average, a number from 0 to 50, more preferably from 0 to 20, even more preferably from 0 to 10 and particularly preferably “b” is 0.

Preferably, “c” in the one or more terminal groups of the formula (IV-a) is 0.

More preferably, “b” and “c” in the one or more terminal groups of the formula (IV-a) are 0.

Even more preferably, in the one or more terminal groups of the formula (IV-a)
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group, and even more preferably CHs,
b and c are both 0, and
a is, based on molar average, a number from 55 to 200, preferably from 55 to 180, more preferably from 55 to 150, even more preferably from 60 to 120 and particularly preferably from 65 to 115.

In a particularly preferred embodiment of the invention, in the one or more terminal groups of the formula (IV-a)
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group, even more preferably CHs,
b and c are both 0, and
a is, based on molar average, a number from 56 to 200, preferably from 59 to 180, more preferably from 62 to 150, even more preferably from 65 to 120 and particularly preferably from 67 to 115.

Extraordinarily preferably, in the one or more terminal groups of the formula (IV-a), R² is CHs, b and c are 0 and a is, based on molar average, a number selected from the group consisting of 56, 67, 79, 90, 102 and 113.

Examples of the one or more terminal groups of the formula (IV) or (IV-a) are terminal groups derived from poly(ethylene glycol) monomethyl ether (mPEG), preferably terminal groups derived from mPEG selected from the group consisting of mPEG2500, mPEG3000, mPEG3500, mPEG4000, mPEG4500 and mPEG5000 and more preferably terminal groups derived from mPEG selected from the group consisting of mPEG3000 and mPEG4000.

The number in the terms beginning with “mPEG” from the previous paragraph describes the average molecular weight of the poly(ethylene glycol) monomethyl ether in g/mol.

In a preferred embodiment of the invention, the polyester of the invention, which is hereinafter referred to as “polyester A”, comprises, and preferably consists of,
one or more structural units of the formula (I), and
one or more structural units of the formula (II) wherein 1/p M^{p+} has the meaning given above, and
one or more structural units of the formula (III) wherein R¹ has the meaning given above and m is an integer from 2 to 4, preferably from 2 to 3, more preferably, the one or more structural units of the formula (III) are selected from the group consisting of —O—CH₂—CH₂—O—, —O—CH₂—CH(CH₃)—O—, —O—CH(CH₃)—CH₂—O— and mixtures thereof, even more preferably the one or more structural units of the formula (III) are selected from the group consisting of —O—CH₂—CH₂—O—, —O—CH₂—CH(CH₃)—O—, —O—CH(CH₃)—CH₂—O— and mixtures thereof whereby the polyester comprises one or more structural units selected from the group consisting of —O—CH₂—CH(CH₃)—O— and —O—CH(CH₃)—CH₂—O—, and particularly preferably, the one or more structural units of the formula (III) are mixtures of one or more structural units —O—CH₂—CH₂—O— and one or more structural units selected from the group consisting of —O—CH₂—CH(CH₃)—O— and —O—CH(CH₃)—CH₂—O—, and
one or more terminal groups of the formula (IV-a)
wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CHs,
a, b and c are, based on molar average, independently of one another, numbers from 0 to 200, the sum of a+b+c is a number of at least 55, preferably from 55 to 200, more preferably from 55 to 180, even more preferably from 55 to 150, particularly preferably from 60 to 120 and extraordinarily preferably from 65 to 115, the [C₂H₄—O], [C₃H₆—O] and/or [C₄H₈—O]units of the one or more terminal groups of the formula (IV-a) may be arranged blockwise, alternating, periodically and/or statistically, preferably blockwise and/or statistically, and either of the [C₂H₄—O], [C₃H₆—O] and [C₄H₈—O]units of the one or more terminal groups of the formula (IV-a) can be linked to —R² and/or —O.

Preferably, in the polyester A
a, b and c are, based on molar average, independently of one another, numbers from 0 to 200, the sum of a+b+c is a number of at least 56, preferably from 56 to 200, more preferably from 59 to 180, even more preferably from 62 to 150, particularly preferably from 65 to 120 and extraordinarily preferably from 67 to 115, the [C₂H₄—O], [C₃H₆—O] and/or [C₄H₈—O]units of the one or more terminal groups of the formula (IV-a) may be arranged blockwise, alternating, periodically and/or statistically, preferably blockwise and/or statistically, and either of the [C₂H₄—O], [C₃H₆—O] and [C₄H₈—O]units of the one or more terminal groups of the formula (IV-a) can be linked to —R² and/or —O.

In a preferred embodiment of the invention, the polyester of the invention comprises one or more structural units of the formula (V)

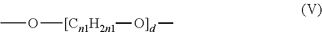

wherein
n1 is 2 or an integer >2, preferably is an integer from 2 to 12, more preferably is an integer from 2 to 6 and even more preferably is an integer from 2 to 4,
d is, based on molar average, a number from 2 to 200, preferably from 3 to 100, more preferably from 4 to 50, and even more preferably from 5 to 25, and whereby the definition of n1 may vary within a single structural unit of the formula (V), and the average number of moles of the one or more structural units of the formula (V), per mole of the polyester, preferably is 0.3 or more than 0.3.

In case that one molecule of the polyesters of the invention comprises two or more of the structural units of the formula (V), the definitions of n1 and d may vary between those structural units.

The one or more the structural units of the formula (V) preferably are derived from polyalkyleneglycol of the formula HO—[Cₙ₁H₂ₙ₁—O]_{d}—H, wherein n1 and d have the meanings given above for formula (V).

The term “polyalkyleneglycol” includes the homopolymers of alkylene oxide (including but not limited to ethylene oxide (EO), propylene oxide (PO) and/or butylene oxide (BO)); or the copolymers of alkylene oxide (including but not limited to ethylene oxide, propylene oxide and/or butylene oxide). When the polyalkyleneglycol is a copolymer, the different types of alkylene oxide may be arranged blockwise, alternating, periodically and/or statistically. Preferably, the polyalkyleneglycol is a homopolymer, preferably a homopopolymer of ethylene oxide, or a block copolymer. Preferred polyalkyleneglycol block copolymers are EO/PO di-block, EO/PO/EO tri-block, PO/EO/PO tri-block.

Preferably, the one or more structural units of the formula (V) are selected from the formula (V-a)

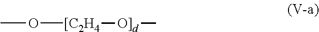

wherein d is, based on molar average, a number from 2 to 200, preferably from 3 to 100, more preferably from 4 to 50, and even more preferably from 5 to 25, and the average number of moles of the one or more structural units of the formula (V-a), per mole of the polyester, preferably is 0.3 or more than 0.3.

In case that one molecule of the polyesters of the invention comprises two or more of the structural units of the formula (V-a), the definition of d may vary between those structural units.

The one or more structural units of the formula (V-a) preferably are derived from polyethyleneglycol of the formula HO—[C₂H₄—O]_{d}—H, wherein d has the meaning given above for formula (V-a).

Particularly preferably, in the one or more structural units of the formula (V-a), d is, based on molar average, a number selected from the group consisting of 4, 6, 9, 11, 22, 34, 45, 56, 68, 79 and 91.

Examples of the one or more structural units of the formula (V) or (V-a) are structural units derived from poly(ethylene glycol) (PEG) and preferably are structural units derived from PEG selected from the group consisting of PEG200, PEG300, PEG400, PEG500, PEG1000, PEG1500, PEG2000, PEG2500, PEG3000, PEG3500 and PEG4000.

The number in the terms beginning with “PEG” from the previous paragraph describes the average molecular weight of the poly(ethylene glycol) in g/mol.

The average number of moles of the one or more structural units of the formula (V), preferably selected from the structural units of the formula (V-a), per mole of the polyester of the invention, preferably is 0.3 or more than 0.3, more preferably is 0.5 or more than 0.5, even more preferably is 0.7 or more than 0.7, particularly preferably is 1 or more than 1 and extraordinarily preferably is 1.

When calculating the average number of moles of the one or more structural units of the formula (V), preferably selected from the structural units of the formula (V-a), per mole of the polyester of the invention, only structural units different from structural units derived from mono alkylene glycols are considered.

In the polyesters of the invention, the one or more structural units of the formula (V) and the one or more structural units of the formula (V-a) are not linked directly to a linear or branched C₁-C₃₀ alkyl group, a cycloalkyl group with 5 to 9 carbon atoms or a C₆-C₃₀ arylalkyl group.

In a further preferred embodiment of the invention, the polyester of the invention comprises one or more structural units which are derived from dicarboxylic acids and/or derivatives thereof and different from the one or more structural units of the formulae (I) and (II). In case the polyester of the invention comprises such one or more structural units which are derived from dicarboxylic acids and/or derivatives thereof and different from the one or more structural units of the formulae (I) and (II), these structural units preferably are derived from substances selected from the group consisting of phthalic acid, isophthalic acid, 3-sulfophthalic acid, 4-sulfophthalic acid, naphthalene-1,4-dicarboxylic acid, naphthalene-2,6-dicarboxylic acid, tetrahydrophthalic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1,4-cyclohexanedicarboxylic acid, cyclohexanediacetic acid, glutaric acid, azelaic acid, and/or derivatives thereof and mixtures thereof. Herein, the term “derivative thereof” comprises, but is not limited to, salts thereof, esters thereof, anhydrides thereof, and any mixtures of the foregoing. In case the aforementioned one or more structural units which are derived from dicarboxylic acids and/or derivatives thereof and different from the one or more structural units of the formulae (I) or (II) comprise a sulfo group, this sulfo group is of the formula —SO₃⁻ 1/p M^{p+}, wherein the cation 1/p M^{p+} preferably has the meaning given above and more preferably is Na⁺.

Typically, such one or more structural units which are derived from dicarboxylic acids and/or derivatives thereof and different from the one or more structural units of the formulae (I) and (II) would be present to a minor extent, preferably in an amount smaller than 5 wt.-%, based on the total weight of the polyester of the invention.

In case the polyester of the invention comprises one or more structural units which are derived from dicarboxylic acids and/or derivatives thereof and different from the one or more structural units of the formulae (I) and (II), these structural units are preferably derived from substances selected from the group consisting of isophthalic acid, 1,4-cyclohexanedicarboxylic acid, 2,5-furandicarboxylic acid, derivatives thereof and mixtures of the aforementioned.

In a further preferred embodiment of the invention, the polyester of the invention comprises one or more anionic terminal groups of the formulae

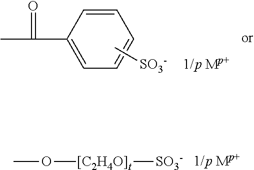

wherein,
1/p M^{p+} is a cation, preferably selected from the group consisting of monovalent cations M⁺ (p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²+, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H, and
t is, based on molar average, a number from 1 to 10, preferably from 1 to 4, and more preferably t is 1.

In a further preferred embodiment of the invention, the polyester of the invention comprises crosslinking structural units derived from one or more crosslinking agents. Herein, the crosslinking agent is defined as an organic molecule which comprises three or more functional groups selected from carboxylic acid group; salts, esters, or anhydrides of carboxylic acid (whereby an anhydride group of carboxylic acids is equivalent to two carboxylic acid groups); hydroxyl group; and any mixture thereof. Examples of crosslinking agents comprise, but are not limited to, citric acid (contains 3 carboxylic acid groups and 1 hydroxyl group), trimellitic acid (contains 3 carboxylic acid groups), glycerol (contains 3 hydroxyl groups), and sugar alcohols such as sorbitol, mannitol, erythritol, etc.

Typically, such crosslinking structural units would be present to a minor extent, preferably in an amount smaller than 5 wt.-%, more preferably in an amount smaller than 3 wt.-%, and even more preferably in an amount smaller than 1 wt.-%, in each case based on the total weight of the polyester of the invention.

Preferably, in the polyester of the invention, the amount of the one or more terminal groups of the formula (IV), preferably selected from the terminal groups of the formula (IV-a), is, in each case based on the total weight of the polyester, at least 40 wt.-%, more preferably at least 50 wt.-% and even more preferably at least 60 wt.-%.

Preferably, in the polyester of the invention, the combined amount of the one or more structural units of the formula (I), and the one or more structural units of the formula (II), and the one or more structural units of the formula (III), preferably selected from the structural units according to the preferred embodiments of the formula (III), and the one or more terminal groups of the formula (IV), preferably selected from the terminal groups of the formula (IV-a), and, if present, the one or more structural units of the formula (V), preferably selected from the structural units of the formula (V-a), is at least 50 wt.-%, more preferably is at least 60 wt.-% and even more preferably is at least 70 wt.-%, in each case based on the total weight of the polyester.

In a preferred embodiment of the invention, the polyester of the invention consists exclusively of the one or more structural units of the formula (I), and of the one or more structural units of the formula (II), and of the one or more structural units of the formula (III), preferably selected from the structural units according to the preferred embodiments of the formula (III), and of the one or more terminal groups of the formula (IV), preferably selected from the terminal groups of the formula (IV-a), and, if present, of the one or more structural units of the formula (V), preferably selected from the structural units of the formula (V-a).

In a more preferred embodiment of the invention, the polyester of the invention consists exclusively of the one or more structural units of the formula (I), and of the one or more structural units of the formula (II), and of the one or more structural units of the formula (III), preferably selected from the structural units according to the preferred embodiments of the formula (III), and of the one or more terminal groups of the formula (IV), preferably selected from the terminal groups of the formula (IV-a).

In another more preferred embodiment of the invention, the polyester of the invention consists exclusively of the one or more structural units of the formula (I), and of the one or more structural units of the formula (II), and of the one or more structural units of the formula (III), preferably selected from the structural units according to the preferred embodiments of the formula (III), and of the one or more terminal groups of the formula (IV), preferably selected from the terminal groups of the formula (IV-a), and of the one or more structural units of the formula (V), preferably selected from the structural units of the formula (V-a).

When no cross-linking agent is used for the preparation of the polyesters of the invention, polyesters are formed which possess a linear structure and contain a terminal group of the formula (IV) at one end of the polyester or a terminal group of the formula (IV) at both ends of the polyester. Preferably, the polyester of the invention possesses a linear structure, i. e. does not comprise cross-linking structures, and contains a terminal group of the formula (IV) at both ends of the polyester. When a cross-linking agent is used for the preparation of the polyesters of the invention, the respective polyesters may comprise more than 2 terminal groups of the formula (IV).

In case the polyester of the invention contains only one terminal group of the formula (IV), the polyester of the invention comprises one or more further terminal groups different from the terminal group of the formula (IV). These terminal groups may result from other reactants used for the preparation of the polyester. Preferably, these terminal groups are selected from the group consisting of —OH, —OCH₃ (these two terminal groups can e. g. occur in case a structural unit of the formula (I) or (II) terminates an end of the polyester), —OR¹OH, wherein R¹ has the meaning given above for formula (III) (this terminal group can e. g. occur in case a structural unit of the formula (III) terminates an end of the polyester), —O—[Cₙ₁H₂ₙ₁—O]_{d}H, wherein n1 and d have the meanings given above for formula (V) and whereby the definition of n1 may vary within a single terminal group (this terminal group can e. g. occur in case a structural unit of the formula (V) terminates an end of the polyester).

In a further preferred embodiment of the invention, the polyester of the invention has the formula (X)

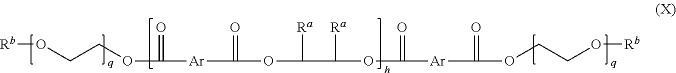

wherein
R^{a} is, each independently, selected from the group consisting of H and CH₃, and preferably the one or more structural units —O—CHR^{a}—CHR^{a}—O— are selected from the group consisting of —O—CH₂—CH₂—O—, —O—CH₂—CH(CH₃)—O—, —O—CH(CH₃)—CH₂—O— and mixtures thereof,
R^{b} is, each independently, a linear C₁-C₆ alkyl group, more preferably CH₃,
q is, based on molar average, each independently, a number of at least 55, preferably from 55 to 200, more preferably from 55 to 180, even more preferably from 55 to 150, particularly preferably from 60 to 120 and extraordinarily preferably from 65 to 115,
Ar represents, each independently

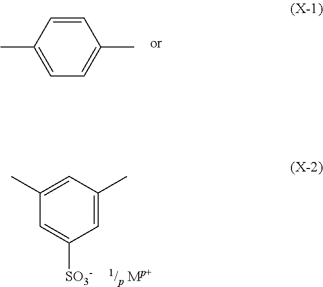

the polyester comprising both, one or more structural units of the formula (X-1) and one or more structural units of the formula (X-2),
1/p M^{p+} is a cation, preferably selected from the group consisting of monovalent cations M⁺ (p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H, and
h is, based on molar average, a number from 1 to 29, preferably from 2 to 21, more preferably from 4 to 15, even more preferably from 5 to 13.

More preferably, in the polyester of the formula (X), the one or more structural units —O—CHR^{a}—CHR^{a}—O— are selected from the group consisting of —O—CH₂—CH₂—O—, —O—CH₂—CH(CH₃)—O—, —O—CH(CH₃)—CH₂—O— and mixtures thereof and the polyester of the formula (X) comprises one or more structural units —O—CHR^{a}—CHR^{a}—O—, wherein one of the two residues R^{a} is H and the other of the two residues R^{a} is CH₃.

Even more preferably, in the polyester of the formula (X), the one or more structural units —O—CHR^{a}—CHR^{a}—O— are mixtures of one or more structural units —O—CH₂—CH₂—O— and one or more structural units —O—CHR^{a}—CHR^{a}—O—, wherein one of the two residues R^{a} is H and the other of the two residues R^{a} is CH₃.

In a preferred embodiment of the invention, “q” in the inventive polyesters of the formula (X) is, based on molar average, each independently, a number of at least 56, more preferably from 56 to 200, even more preferably from 59 to 180, particularly preferably from 62 to 150, extraordinarily preferably from 65 to 120 and especially preferably from 67 to 115.

It is to be understood that the polyesters of the invention are typically prepared by polycondensation processes. This leads to statistically determined mixtures of polyesters in which a mixture of molecular species with a distribution around a molar average is obtained. Furthermore, small amounts of polyester may be present within the statistically determined mixtures of polyesters which do not comprise structural units of the formula (I) or (II).

Preferably, the weight average molecular weight (MW) of the polyester of the invention is from 3000 to 20000 g/mol, preferably from 4000 to 18000 g/mol.

The weight average molecular weight (MW) of the polyesters of the invention may be determined by gel permeation chromatography (GPC) analysis, preferably as detailed in the following: 20 μl of sample with a concentration of 1 mg/ml dissolved in tetrahydrofuran (THF)/H₂O 80:20 (v:v) is injected onto a PSS Suprema column set of two columns with the dimensions 300 mm length and 8 mm internal diameter (ID) with a porosity of 30 Å and particle size 10 μm. The detection is monitored at 235 nm on a multiple wavelength detector. The employed eluent is 1.25 g/l of disodium hydrogen phosphate dihydrate in a 45/55% (v/v) water/acetonitrile mixture. Separations are conducted at a flowrate of 1 ml/minute and 25° C. Quantification is performed by externally calibrating standard samples of different molecular weight polyethylene glycols (430 g/mol-44000 g/mol). The used SEC columns are consisting of a modified acrylate copolymer network.

The groups (C₂H₄) in the terminal groups of the formula (IV-a) and the structural units of the formula (V-a) preferably are of the formula —CH₂—CH₂—. The same applies in case the structural units of the formula (III) or (V) or the terminal groups of the formula (IV) comprise one or more groups (C₂H₄).

The groups (C₃H₆) in the terminal groups of the formula (IV-a) preferably are of the formula —CH(CH₃)—CH₂— or —CH₂—CH(CH₃)—, i. e. of the formula

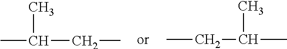

The same applies in case the structural units of the formula (III) or (V) or the terminal groups of the formula (IV) comprise one or more groups (C₃H₆).

The groups (C₄H₈) in the terminal groups of the formula (IV-a) preferably are of the formula —CH(CH₃)—CH(CH₃)—, i. e. of the formula

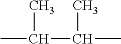

The same applies in case the structural units of the formula (III) or (V) or the terminal groups of the formula (IV) comprise one or more groups (C₄H₈).

In the polyesters of the invention, the structural units or terminal groups of the formula (III), (III-1), (III-2), (IV), (IV-a), (V) or (V-a) generally are linked directly to structural units of the formula (I) or (II). Ester groups result. However, in the polyesters of the invention, the structural units or terminal groups of the formula (III), (III-1), (III-2), (IV), (IV-a), (V) or (V-a) generally are not linked directly to other structural units or terminal groups of the formula (III), (III-1), (III-2), (IV), (IV-a), (V) or (V-a). Likewise, in the polyesters of the invention, the structural units of the formula (I) or (II) generally are not linked directly to other structural units of the formula (I) or (II).

For the preparation of the polyesters of the invention, typically a two-stage process is used of either direct esterification of dicarboxylic acids and diols or transesterification of (i) diesters of dicarboxylic acids and (ii) diols, followed by a polycondensation reaction under reduced pressure.

A further subject matter of the invention is a process for the preparation of the polyesters of the invention, comprising the steps of heating
terephthalic acid and/or a derivative thereof, preferably dimethyl terephthalate, and
5-sulfoisophthalic acid and/or a derivative thereof, preferably dimethyl-5-sulfoisophthalate sodium salt, and
one or more alkylene glycols of the formula HO—R¹—OH wherein R¹ has the meaning given above for formula (III), and preferably one or more alkylene glycols corresponding to the preferred embodiments of the formula (III), and
one or more substances of the formula HO—[CₙH₂ₙ—O]ₓ—R² wherein n, x and R² have the meanings given above for formula (IV) and whereby the definition of n may vary within a single molecule of the formula HO—[CₙH₂ₙ—O]ₓ—R², and preferably one or more substances of the formula HO—[C₂H₄—O]ₐ—[C₃H₆—O]_{b}—[C₄H₈—O]_{c}—R² wherein a, b, c, the sum of a+b+c, and R² have the meanings given above for formula (IV-a) and whereby the [C₂H₄—O], [C₃H₆—O] and/or [C₄H₈—O]units of the one or more substances of the formula HO—[C₂H₄—O]ₐ—[C₃H₆—O]_{b}—[C₄H₈—O]_{c}—R² may be arranged blockwise, alternating, periodically and/or statistically, preferably blockwise and/or statistically, and either of the [C₂H₄—O], [C₃H₆—O] and [C₄H₈—O]units of the one or more substances of the formula HO—[C₂H₄—O]ₐ—[C₃H₆—O]_{b}—[C₄H₈—O]_{c}—R² can be linked to —R² and/or —OH,
and, optionally,
one or more substances of the formula HO—[Cₙ₁H₂ₙ₁—O]_{d}H wherein n1 and d have the meanings given above for formula (V) and whereby the definition of n1 may vary within a single molecule of the formula HO—[Cₙ₁H₂ₙ₁—O]_{d}H, and preferably one or more substances of the formula HO—[C₂H₄—O]_{d}H wherein d has the meaning given above for formula (V-a),
with the addition of a catalyst, to temperatures of 160 to 220° C., preferably beginning at atmospheric pressure, and then continuing the reaction under reduced pressure at temperatures of from 160 to 240° C.

Reduced pressure preferably means a pressure of from 0.1 to 900 mbar and more preferably a pressure of from 0.5 to 500 mbar.

In a preferred embodiment of the process of the invention, individual components or reactants may be added at different times during the reaction process but preferably before the reaction is continued under reduced pressure at temperatures of from 160 to 240° C.

Typical transesterification and condensation catalysts known in the art can be used for the inventive process for the preparation of the polyesters of the invention, such as antimony, germanium and titanium-based catalysts. Preferably, tetraisopropyl orthotitanate (IPT) and sodium acetate (NaOAc) are used as the catalyst system in the inventive process for the preparation of the polyesters of the invention.

The polyesters of the invention may be used in substance, i. e. as granules, but may also be provided as solutions or dispersions. The latter two exhibit beneficial handling properties and are more easily dosed. Preferably, the solutions or dispersions comprise the polyesters of the invention in an amount of from 10 to 80 wt.-% based on the total weight of the solution or dispersion. Suitable solvents for such solutions or dispersions are for example water, ethanol, propanol, butanol, ethylene glycol, 1,2-propylene glycol, 1,3-propylene glycol, 1,2-butylene glycol, 1,3-butylene glycol, 1,4-butylene glycol, butyl glycol, butyl diglycol, butyl polyglycol, glycerol or mixtures thereof. These solvents are preferably used in an amount of from 20 to 90 wt.-%, based on the total weight of the solution or dispersion.

A further subject matter of the invention is solutions or dispersions comprising one or more polyesters of the invention, preferably in an amount of from 10 to 80 wt.-%, based on the total weight of the solution or dispersion, and one or more solvents selected from the group consisting of water, ethanol, propanol, butanol, ethylene glycol, 1,2-propylene glycol, 1,3-propylene glycol, 1,2-butylene glycol, 1,3-butylene glycol, 1,4-butylene glycol, butyl glycol, butyl diglycol, butyl polyglycol, glycerol, and mixtures thereof, preferably in an amount of from 20 to 90 wt.-%, in each case based on the total weight of the solution or dispersion.

In a preferred embodiment of the invention, the solution or dispersion of the invention further comprises one or more polyesters different from the polyesters of the invention, preferably nonionic polyesters, more preferably nonionic polyesters showing a detergency enhancement during laundry applications and even more preferably nonionic soil release polyesters.

The nonionic soil release polymer or polyester can be biodegradable or non-biodegradable, but preferably is biodegradable. Suitable nonionic soil release polyesters include, for example, but are not limited to, Texcare SRN260 or TexCare SRN170 from Clariant.

The solution or dispersion of the invention may be transparent or opaque, white or slightly yellowish. The solution or dispersion of the invention may be used to provide an opaque appearance for the finished product or for a part of the finished product.

The raw materials for the preparation of the polyesters of the invention can be based on fossil carbon or renewable carbon. Renewable carbon includes carbon originating from biomass, carbon capture, or chemical recycling. Preferably, the raw materials for the preparation of the polyesters of the invention are at least partly based on renewable carbon. The Renewable Carbon Index (RCI, a measure of sustainability by dividing the number of carbons derived from renewable sources by the total number of carbons in an active ingredient) of the polyesters of the invention preferably is above 40%, more preferably above 50%, even more preferably above 60%, particularly preferably from 70 to 100%, and most preferably 100%. In a preferred embodiment of the invention, all the —CH₂—CH₂—O— structural units within structural units of the formula (III-2), structural units of the formula (V-a) and terminal groups of the formula (IV-a), as well as all the —CH₂—CH₂—O— structural units within structural units of the formula (III), structural units of the formula (V) and terminal groups of the formula (IV), in case these comprise one or more structural units —CH₂—CH₂—O—, are bio-based, and the polyesters of the invention have a RCI above 40%, preferably from 50 to 95% and more preferably from 60 to 85%.

The polyesters of the present invention in particular show advantageous performance in laundry detergent compositions, preferably advantageous washing performance in laundry detergent compositions, and possess advantageous biodegradability.

During the use of fabric and home care compositions comprising the polyester of the invention, the polyester can deposit on surfaces, especially fabric surfaces which comprise synthetic fibers, such as polyester, etc. The deposition of the polyester of the invention gives anti-fouling properties to the fabric surfaces: various soil (including body soil, grease soil, clay, biological stains, or microorganisms) have reduced adhesion to the polyester treated fabric surfaces, so that less soil can deposit on these surfaces during wash and wear. Furthermore, when soil is attached to a fabric surface treated with a polyester of the invention, it can be more easily removed in later washing procedures because of reduced adhesion between soil and fabric. Overall, the polyester of the invention can bring various benefits including reduced soil deposition onto the fabric during the washing process and during wear, reduced adhesion of microorganisms and allergens onto the fabric, whiteness maintenance, easier soil removal from fabrics which have been treated with a polyester of the invention in a previous washing process, i.e. soil release performance, malodor reduction or control, improved or maintained wicking properties of a fabric, etc.

Furthermore, the polyesters of the invention show advantageous processability and advantageous stability, e. g. in fabric and home care compositions such as laundry detergent compositions.

Fabric and home care compositions, such as laundry detergent compositions, comprising the polyesters of the invention may contain further ingredients well-known to the person skilled in the art and can be prepared according to methods also well-known to the person skilled in the art.

The amount of the polyester of the invention in fabric and home care compositions such as in laundry detergent compositions preferably is from 0.01 to 10.0 wt.-%, more preferably from 0.05 to 5.0 wt.-% and even more preferably from 0.1 to 3.0 wt.-%, in each case based on the total weight of the fabric and home care composition.

### EXAMPLES

The examples below are intended to illustrate the invention in detail without, however, limiting it thereto. Unless explicitly stated otherwise, all percentages given are percentages by weight (% by wt. or wt.-%).

### Polyester Preparation

General procedure for the preparation of the polyesters of the examples: The polyester synthesis is carried out by the reaction of dimethyl terephthalate (DMT), dimethyl-5-sulfoisophthalate sodium salt (5-SIM), 1,2-propylene glycol, ethylene glycol, and alkyl capped polyalkylene glycol (mono hydroxyl-functional polyalkylene glycol monoalkyl ether), using sodium acetate (NaOAc) and tetraisopropyl orthotitanate (IPT) as the catalyst system. The synthesis is a two-step procedure. The first step is a trans-esterification and the second step is a polycondensation.

Key to reactants or ingredients used in the examples:
5-SIM is dimethyl-5-sulfoisophthalate sodium salt
AE NI is alkyl ethoxylate (EO)₇
AES is alcohol ethoxysulfate
DMT is dimethyl terephthalate
EG is ethylene glycol
HEDP is 1-hydroxyethane-1,1-diphosphonic acid
IPT is tetraisopropyl orthotitanate
LAS is linear alkyl benzene sulphonate
MGDA is methylglycine-diacetic acid
mPEG3000 is mono hydroxyl-functional polyethylene glycol monomethyl ether, average molecular weight 3000 g/mol
mPEG4000 is mono hydroxyl-functional polyethylene glycol monomethyl ether, average molecular weight 4000 g/mol
NaOAc is sodium acetate
PG is 1,2-propylene glycol

### Inventive Polyester Example 1

58.26 g (0.30 mol) of dimethyl terephthalate (DMT), 29.63 g (0.10 mol) of dimethyl-5-sulfoisophthalate sodium salt (5-SIM), 28.04 g (0.373 mol) of 1,2-propylene glycol (PG), 24.19 g (0.39 mol) of ethylene glycol (EG), 210 g (0.07 mol) of mPEG3000 and 0.38 g of sodium acetate (NaOAc) (anhydrous) are weighed into a reaction vessel at room temperature. For the melting process and homogenization, the mixture is heated up to 110-120° C. 134 μL of tetraisopropyl orthotitanate (IPT) is added and the mixture is further heated up to 210° C. over 3 hours sparged by a nitrogen stream. During the transesterification methanol is released from the reaction and is distilled out of the system. Once the head-temperature is below 55° C., nitrogen is switched off and the pressure is reduced to 10 mbar. PG and EG are distilled out of the system. The mixture is stirred for further 4 hours at a pressure of 10 mbar. The reaction mixture is cooled down to 140-150° C. Vacuum is released with nitrogen and the polyester is transferred out of the reactor.

### Inventive Polyester Example 2

Inventive polyester example 2 is synthesized according to inventive polyester example 1 with monomer type and dosage described in Table 1.

TABLE 1
Monomer type and dosage for the preparation
of inventive polyesters 1 and 2

| | Inventive | Inventive |
|---|---|---|
| Monomer | polyester 1 | polyester 2 |
| DMT (g) | 58.26 | 29.13 |
| 5-SIM (g) | 29.63 | 14.81 |
| PG (g) | 28.04 | 14.02 |
| EG (g) | 24.19 | 12.10 |
| Type of terminal unit | mPEG3000 | mPEG4000 |
| (end-cap) | | |
| End-cap (g) | 210 | 140 |
| NaOAc (g) | 0.38 | 0.19 |
| IPT (μL) | 134 | 80 |

The average amount of the monomers in a polyester is calculated as 1) a polyester has end-caps on both sides, 2) used DMT and 5-SIM are equally integrated into a polyester and 3) the excess amount of PG and EG are equally distilled out of the system.

### Method of Testing Biodegradability of Polyesters:

The biodegradability of polyesters is determined following the OECD 301B Ready Biodegradability CO₂ Evolution Test Guideline. In this study, the test substance is the sole carbon and energy source and under aerobic conditions microorganisms metabolize the test substance producing CO₂ or incorporating the carbon into biomass. The amount of CO₂ produced by the test substance (corrected for the CO₂ evolved by the blank inoculum) is expressed as a percentage of the theoretical amount of CO₂ (ThCO₂) that could have been produced if the organic carbon in the test substance was completely converted to CO₂.

### Method of Evaluating Whiteness Benefit of Polyesters

During the laundry process, soil which has been removed from dirty clothes is suspended in the detergent solution. Some suspended soil can redeposit back onto clothes. Whiteness maintenance performance is the ability of a detergent to keep white items from whiteness loss when they are washed in the presence of soils.

The whiteness benefit of polyesters is evaluated using automatic Tergotometer with 10 pots for laundry formulation testing. SBL2004 test soil strips supplied by WFK Testgewebe GmbH are used to simulate consumer soil levels. On average, every 1 SBL2004 strip is loaded with 8 g soil. The SBL2004 test soil strips were cut into 5×5 cm squares for use in the test. White Fabric swatches below from WFK Testgewebe GmbH are typically used as whiteness tracers. Codes for the used fabric are summarized in Table 2.

TABLE 2
Codes for fabrics

| Code | Fiber Content | % Fiber Content | Fabric Construction | Size |
|---|---|---|---|---|
| CK | Cotton | 100 | Weft Knit | (5 × 5 cm) |
| PC | Polyester/cotton | 65/35 | Weave | (5 × 5 cm) |
| PE | Polyester | 100 | Weft Knit | (5 × 5 cm) |
| PS | Polyester/SpandexTM | 95/5 | Weft Knit | (5 × 5 cm) |

Additional ballast (background fabric swatches) is also used to simulate a fabric load and provide mechanical energy during the real laundry process. Ballast loads are comprised of cotton and polycotton knit swatches at 5×5 cm size.

4 cycles of wash are needed to complete the test:
Cycle 1: Desired amount of detergent is fully dissolved by mixing with 1 L water (at defined hardness) in each tergotometer pot. 60 grams of fabrics, including whiteness tracers (4 types, each with 4 replicates), 31 pieces 5×5 cm SBL2004, and ballast are washed and rinsed in the tergotometer pot under defined conditions.
Cycle 2: The whiteness tracers and ballast from each pot are then washed and rinsed again together with a new set of SBL2004 (5×5 cm, 31 pieces) following the process of cycle 1. All other conditions remain the same as in cycle 1.
Cycle 3: The whiteness tracers and ballast from each pot are then washed and rinsed again together with a new set of SBL2004 (5×5 cm, 31 pieces) following the process of cycle 1. All other conditions remain the same as in cycle 1.
Cycle 4: The whiteness tracers and ballast from each pot are then washed and rinsed again together with a new set of SBL2004 (5×5 cm, 31 pieces) following the process of cycle 1. All other conditions remain the same as in cycle 1.

After Cycle 4, all whiteness tracers & ballast are tumble dried between 60-65° C. until dry, then the WI(CIE) of the dry tracers is measured using Konica Minolta CM-3610D spectrophotometer.

### Method for Evaluating Soil Release Performance of Polyesters

Soil release test were performed to assess how easy the stains can be removed from a fabric surface after the fabric surface has been modified by polyesters in previous washing cycles.

Polyester (PE) fabrics from WFK Testgewebe GmbH were cut into 5×5 cm fabric swatches for the soil release test. 3 pieces of 5×5 cm fabric swatches were washed 4 cycles using detergent composition in an automatic tergotometer. After drying overnight under humidity and temperature control (50% RH, 20±2° C.), 200 μl dirty motor oil (DMO) was applied onto each square of fabric swatches. After drying overnight, the DMO soiled fabric swatches are then washed again using detergent compositions, together with knitted cotton ballast (total weight of ballast and DMO soiled fabric swatches is 60 g, in every 1 L pots of tergotometer). The washed polyester swatches are then dried overnight for image analysis.

Stain images were collected before and after washing against a white background with a reflection spectro-photometer (DigiEye). Images were analyzed using DigiEye software. For each fabric the color of the motor oil stains was evaluated by measuring the coordinates Ln*, an*, and bn* defined in the CIELAB colour system. From the measured coordinates the differences in lightness (Δ Ln*), redness (Δan*), and blueness (Δbn*) in contrast to the background were calculated. The relative color changes, ΔE*, were calculated comparing the coordinates variation before (n=1) and after the wash (n=2) by applying the following equations:

$$Δ {E}_{pre - wash} = \sqrt{[ {( {L}_{Clean} - {L}_{Stained} )}^{2} + {( {a}_{Clean} - {a}_{Stained} )}^{2} + {( {b}_{Clean} - {b}_{Stained} )}^{2} ]}$$

$$and$$

$$Δ {E}_{post - wash} = \sqrt{[ {( {L}_{Clean} - {L}_{Washed} )}^{2} + {( {a}_{Clean} - {a}_{Washed} )}^{2} + {( {b}_{Clean} - {b}_{Washed} )}^{2} ]}$$

Lastly, the stain removal index (SRI) was assessed as follows:

$$SRI = ( \frac{Δ {E}_{pre - wash} - Δ {E}_{post - wash}}{Δ {E}_{pre - wash}} ) \times 100$$

### Biodegradability of Polyesters

Biodegradability of polyesters is evaluated using the method described above. The biodegradation test result shows that inventive polyesters have advantageous biodegradability and degraded by more than 60% at 28 days as summarized in Table 3.

TABLE 3
Biodegradability test results for inventive polyesters 1 and 2

| Inventive polyester | 1 | 2 |
|---|---|---|
| Biodegradability (%)* | 63 | 70 |

*% ThCO₂ evolution at 28 days

### Whiteness and Soil Release Performance (in Liquid Detergent)

Water soluble unit dose liquid compositions CC1 (Comparative), IC1 (Inventive) and IC2 (inventive) are prepared by traditional means known to those of ordinary skill in the art by mixing the listed ingredients (Table 4). The whiteness performance of compositions CC1, IC1 and IC2 are evaluated according to the method described above, ΔWI(CIF) of compositions IC1 and IC2 versus composition CC1 is reported in Table 4. The soil release performance of compositions CC1, IC1 and IC2 are evaluated according to the method described above, ΔSRI of compositions IC1 and IC2 versus composition CC1 is reported in Table 4. The wash concentration of the composition is 1984 ppm, the concentration of water-soluble film is 47 ppm, the wash temperature is 35° C., water hardness is 2 gpg. The results in Table 4 show that inventive compositions IC1 and IC2 show strong whiteness and soil release performance versus composition CC1.

TABLE 4
Ingredients of compositions CC1, IC1 and IC2 and ΔWI(CIE)- and ΔSRI-
values of compositions IC1 and IC2 versus composition CC1

| | CC1 | | |
|---|---|---|---|
| Ingredients (wt.-%) | (Reference) | IC1 | IC2 |
| LAS | 24.52 | 24.52 | 24.52 |
| AES | 12.62 | 12.62 | 12.62 |
| AE NI | 2.02 | 2.02 | 2.02 |
| Suds Suppressor | 0.30 | 0.30 | 0.30 |
| Inventive polyester 1 | 0.00 | 0.30 | 0.00 |
| Inventive polyester 2 | 0.00 | 0.00 | 0.30 |
| HEDP | 2.23 | 2.23 | 2.23 |
| Monoethanolamine | 8.10 | 8.10 | 8.10 |
| 1,2-Propylene glycol | 12.72 | 12.72 | 12.72 |
| Dipropyleneglycol | 0.84 | 0.84 | 0.84 |
| K₂SO₃ | 0.35 | 0.35 | 0.35 |
| MgCl₂ | 0.32 | 0.32 | 0.32 |
| Citric Acid | 0.70 | 0.70 | 0.70 |
| Fatty Acid | 1.61 | 1.61 | 1.61 |
| Glycerol | 4.76 | 4.76 | 4.76 |
| Brightener | 0.04 | 0.04 | 0.04 |
| Blue dye | 0.0014 | 0.0014 | 0.0014 |
| Enzyme (including Protease, | 0.087 | 0.087 | 0.087 |
| Amylase, and Mannanase) | | | |
| Preservative | 0.009 | 0.009 | 0.009 |
| Hydrogenated castor oil | 0.09 | 0.09 | 0.09 |
| Perfume | 2.05 | 2.05 | 2.05 |
| Water/minors | Balance | Balance | Balance |
| _{A}WI(CIE) vs Reference ^{a} | 0 | +22.8 | +22.2 |
| ΔSRI vs Reference ^{b} | 0 | +75.8 | +72.0 |

^{a} Fabric: 100% Polyester Knit (PE).
^{b} Fabric: 100% Polyester Knit (PE), stained with Dirty Motor Oil.

Water soluble unit dose liquid compositions CC1 (Comparative) and IC3-IC6 (inventive) are prepared by traditional means known to those of ordinary skill in the art by mixing the listed ingredients (Table 5). The soil release performance of compositions CC1 and IC3-IC6 are evaluated according to the method described above, the wash concentration of the composition is 1984 ppm, the concentration of the water-soluble film is 47 ppm, the wash temperature is 35° C., water hardness is 20 gpg. ASRI of compositions IC3-IC6 versus composition CC1 is reported in Table 5, inventive compositions IC3-IC6 show stronger soil release performance versus composition CC1.

TABLE 5
Ingredients of compositions CC1 and IC3-IC6 and ΔSRI-
values of compositions IC3-IC6 versus composition CC1

| | CC1 | | | | |
|---|---|---|---|---|---|
| Ingredients (wt.-%) | (Reference) | IC3 | IC4 | IC5 | IC6 |
| LAS | 24.52 | 24.52 | 24.52 | 24.52 | 24.52 |
| AES | 12.62 | 12.62 | 12.62 | 12.62 | 12.62 |
| AE NI | 2.02 | 2.02 | 2.02 | 2.02 | 2.02 |
| Suds Suppressor | 0.30 | 0.30 | 0.30 | 0.30 | 0.30 |
| Inventive polyester 2 | 0.00 | 0.20 | 0.175 | 0.15 | 0.10 |
| Texcare SRN260 | 0.00 | 0.00 | 0.025 | 0.05 | 0.10 |
| HEDP | 2.23 | 2.23 | 2.23 | 2.23 | 2.23 |
| Monoethanolamine | 8.10 | 8.10 | 8.10 | 8.10 | 8.10 |
| 1,2-Propylene glycol | 12.72 | 12.72 | 12.72 | 12.72 | 12.72 |
| Dipropyleneglycol | 0.84 | 0.84 | 0.84 | 0.84 | 0.84 |
| K₂SO₃ | 0.35 | 0.35 | 0.35 | 0.35 | 0.35 |
| MgCl₂ | 0.32 | 0.32 | 0.32 | 0.32 | 0.32 |
| Citric Acid | 0.70 | 0.70 | 0.70 | 0.70 | 0.70 |
| Fatty Acid | 1.61 | 1.61 | 1.61 | 1.61 | 1.61 |
| Glycerol | 4.76 | 4.76 | 4.76 | 4.76 | 4.76 |
| Brightener | 0.04 | 0.04 | 0.04 | 0.04 | 0.04 |
| Blue dye | 0.0014 | 0.0014 | 0.0014 | 0.0014 | 0.0014 |
| Enzyme (including | 0.087 | 0.087 | 0.087 | 0.087 | 0.087 |
| Protease, Amylase, | | | | | |
| and Mannanase) | | | | | |
| Preservative | 0.009 | 0.009 | 0.009 | 0.009 | 0.009 |
| Hydrogenated castor | 0.09 | 0.09 | 0.09 | 0.09 | 0.09 |
| oil | | | | | |
| Perfume | 2.05 | 2.05 | 2.05 | 2.05 | 2.05 |
| Water/minors | Balance | Balance | Balance | Balance | Balance |
| ΔSRI vs Reference ^{b} | 0 | +74.8 | +76.3 | +74.9 | +74.5 |

^{a} Fabric: 100% Polyester Knit (PE).
^{b} Fabric: 100% Polyester Knit (PE), stained with Dirty Motor Oil.

### Whiteness Performance (in Powder Detergent)

Powder detergent compositions CC2 (comparative), IC7 (inventive) and IC8 (inventive) below are prepared by traditional means known to those of ordinary skill in the art by mixing the listed ingredients (Table 6). The whiteness performance of compositions CC2, IC7 and IC8 are evaluated according to the method described above. The wash concentration of the powder detergent is 4643 ppm (water hardness 20 gpg, and temperature 35° C.). ΔWI(CIF) of compositions IC7 and IC8 versus composition CC2 is reported in Table 6. Compositions IC7 and IC8 show strong whiteness performance versus composition CC2.

TABLE 6
Ingredients of compositions CC2, IC7 and IC8 and ΔWI(CIE)-
values of compositions IC7 and IC8 versus composition CC2

| Ingredients (wt.-%) | CC2 | IC7 | IC8 |
|---|---|---|---|
| LAS | 8.50 | 8.50 | 8.50 |
| AE NI | 1.25 | 1.25 | 1.25 |
| MGDA | 0.37 | 0.37 | 0.37 |
| HEDP | 0.26 | 0.26 | 0.26 |
| Citric Acid | 0.013 | 0.013 | 0.013 |
| Brightener | 0.153 | 0.153 | 0.153 |
| Enzyme (including Protease, | 0.44 | 0.44 | 0.44 |
| Amylase, and Mannanase) | | | |
| Sodium Sulphate | 36.42 | 36.42 | 36.42 |
| Blocky carboxymethyl cellulose | 0.16 | 0.16 | 0.16 |
| Polycarboxylate polymer ^{b} | 0.38 | 0.38 | 0.38 |
| Sodium Carbonate | 8.40 | 8.40 | 8.40 |
| Sodium Silicate | 7.22 | 7.22 | 7.22 |
| Sodium Percarbonate | 11.09 | 11.09 | 11.09 |
| Perfume | 0.60 | 0.60 | 0.60 |
| Hueing Dye | 0.027 | 0.027 | 0.027 |
| Suds Suppressor | 0.037 | 0.037 | 0.037 |
| Inventive polyester 1 | 0.00 | 0.30 | 0.00 |
| Inventive polyester 2 | 0.00 | 0.00 | 0.30 |
| Water/minors | Balance | Balance | Balance |
| ΔWI(CIE) vs Reference ^{a} | 0 | +26.5 | +27.2 |

^{a} Fabric: 100% Polyester Knit (PE), test with SBL.
^{b} polycarboxylate derived from 1-(allyloxy)-3-butoxypropan-2-ol, acrylic acid, and 3-allyloxy-2-hydroxy-1-propanesulfonic acid, which has a weight average molecular weight of from about 30,000 to about 60,000.

1-15. (canceled)

16. A polyester comprising
A) one or more structural units of the formula (I) 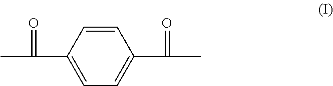
and
B) one or more structural units of the formula (II) 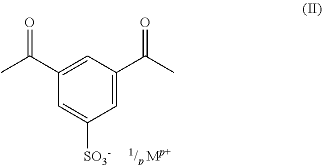
wherein
1/p M^{p+} is a cation, selected from the group consisting of monovalent cations M⁺ (p=1), divalent cations ½ M²⁺ (p=2) and trivalent cations ⅓ M³⁺ (p=3),
and
C) one or more structural units of the formula (III) 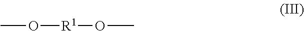
wherein R¹ is a linear or branched alkylene group of the formula (CₘH₂ₘ),
where m is an integer from 2 to 12,
and
D) one or more terminal groups of the formula (IV) 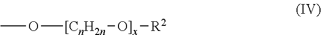
wherein
R² is a linear or branched C₁-C₃₀ alkyl group, a cycloalkyl group with 5 to 9 carbon atoms, or a C₆-C₃₀ arylalkyl group,
n is an integer from 2 to 12, whereby the definition of n may vary within a single terminal group of the formula (IV), and
x is, based on molar average, a number of at least 55.

17. The polyester according to claim 16, wherein the polyester comprises one or more structural units of the formula (III) where m is 3.

18. The polyester according to claim 16, wherein the polyester comprises one or more structural units of the formula (III) where m is 2 and one or more structural units of the formula (III) where m is 3.

19. The polyester according to claim 16, wherein x in formula (IV) is, based on molar average, a number of at least 56 and n in formula (IV) is 2.

20. The polyester according to claim 16, wherein the one or more terminal groups of the formula (IV) are of the formula (IV-a) 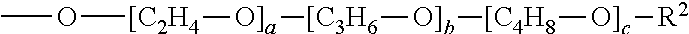
wherein
R² is a linear or branched C₁-C₃₀ alkyl group, a cycloalkyl group with 5 to 9 carbon atoms, or a C₆-C₃₀ arylalkyl group;
a, b and c are each, independently, numbers from 0 to 200, based on molar average;
the sum of a+b+c is a number of at least 55;
the [C₂H₄—O], [C₃H₆—O], and/or [C₄H₈—O]units may be arranged blockwise, alternating, periodically and/or statistically; and
any of the [C₂H₄—O], [C₃H₆—O], and/or [C₄H₈—O]units can be linked to —R² and/or —O.

21. The polyester according to claim 20, wherein the sum of a+b+c in the one or more terminal groups of the formula (IV-a) is a number of at least 56 and both b and c in the one or more terminal groups of the formula (IV-a) are 0.

22. The polyester according to claim 16, wherein the polyester further comprises one or more structural units of the formula (V) 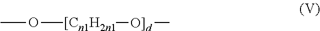
wherein
n1 is an integer from 2 to 12, whereby the definition of n1 may vary within a single structural unit of the formula (V);
d is, based on molar average, a number from 2 to 200; and
the average number of moles of the one or more structural units of the formula (V) per mole of the polyester is equal to or greater than 0.3.

23. The polyester according to claim 22, wherein the one or more structural units of the formula (V) are of the formula (V-a) 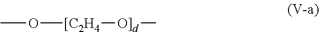
wherein
d is, based on molar average, a number from 2 to 200; and
the average number of moles of the one or more structural units of the formula (V-a) per mole of the polyester is equal to or greater than 0.3.

24. The polyester according to claim 16, wherein the one or more terminal groups of the formula (IV) is present in an amount that is at least 40 wt.-% of the total weight of the polyester.

25. The polyester according to claim 16, wherein the combined amount of all structural units is at least 50 wt.-% of the total weight of the polyester.

26. The polyester according to claim 16, wherein the polyester has a weight average molecular weight of from 3000 to 20000 g/mol.

27. A process for the preparation of a polyester according to claim 16, wherein the process comprises
heating
terephthalic acid and/or a derivative thereof;
5-sulfoisophthalic acid and/or a derivative thereof;
one or more alkylene glycols of the formula HO—R¹—OH, wherein R¹ is a linear or branched alkylene group of the formula (CₘH₂ₘ), where m is an integer from 2 to 12;
one or more substances of the formula HO—[CₙH₂ₙ—O]ₓ—R₂, wherein R² is a linear or branched C₁-C₃₀ alkyl group, a cycloalkyl group with 5 to 9 carbon atoms or a C₆-C₃₀ arylalkyl group; n is an integer from 2 to 12, whereby the definition of n may vary within a single molecule of the formula HO—[CₙH₂ₙ—O]ₓ—R₂; and x is, based on molar average, a number of at least 56; and
one or more substances of the formula HO—[C₂H₄—O]ₐ—[C₃H₆—O]_{b}—[C₄H₈—O]_{c}—R², wherein R² is a linear or branched C₁-C₃₀ alkyl group, a cycloalkyl group with 5 to 9 carbon atoms, or a C₆-C₃₀ arylalkyl group; a, b and c are each, independently, numbers from 0 to 200, based on molar average; the sum of a+b+c is a number of at least 56; the [C₂H₄—O], [C₃H₆—O], and/or [C₄H₈—O]units may be arranged blockwise, alternating, periodically and/or statistically; and any of the [C₂H₄—O], [C₃H₆—O], and/or [C₄H₈—O]units can be linked to —R² and/or —O;
optionally, one or more substances of the formula HO—[Cₙ₁H₂ₙ₁—O]_{d}—H, wherein n1 is an integer from 2 to 12, whereby the definition of n1 may vary within a single molecule of the formula HO—[Cₙ₁H₂ₙ₁—O]_{d}—H; d is, based on molar average, a number from 2 to 200; and
optionally, ethylene glycol,
with the addition of a catalyst, to temperatures of 160 to 220° C., beginning at atmospheric pressure, and then continuing the reaction under reduced pressure at temperatures of from 160 to 240° C.

28. A solution or dispersion comprising
one or more polyesters according to claim 16, in an amount of from 10 to 80 wt.-%, based on the total weight of the solution or dispersion; and
one or more solvents selected from the group consisting of water, ethanol, propanol, butanol, ethylene glycol, 1,2-propylene glycol, 1,3-propylene glycol, 1,2-butylene glycol, 1,3-butylene glycol, 1,4-butylene glycol, butyl glycol, butyl diglycol, butyl polyglycol, glycerol, and mixtures thereof, in an amount of from 20 to 90 wt.-%, based on the total weight of the solution or dispersion.

29. The solution or dispersion according to claim 28, wherein the solution or dispersion further comprises one or more nonionic soil release polyesters.

30. A polyester comprising
A) one or more structural units of the formula (I) 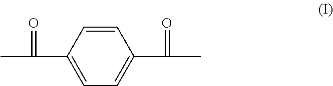
and
B) one or more structural units of the formula (II) 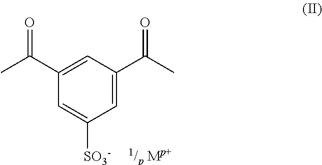
wherein
1/p M^{p+} is a cation, selected from the group consisting of monovalent cations M⁺ (p=1), divalent cations ½ M²⁺ (p=2) and trivalent cations ⅓ M³⁺ (p=3),
and
C) one or more structural units of the formula (III) 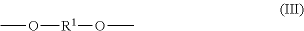
wherein R¹ is a linear or branched alkylene group of the formula (CₘH₂ₘ),
where m is an integer from 2 to 12,
and
D) one or more terminal groups of the formula (IV-a) 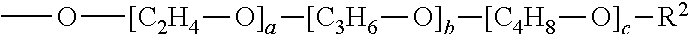
wherein
R² is a linear or branched C₁-C₃₀ alkyl group, a cycloalkyl group with 5 to 9 carbon atoms, or a C₆-C₃₀ arylalkyl group;
a, b and c are each, independently, numbers from 0 to 200, based on molar average;
the sum of a+b+c is a number of at least 55;
the [C₂H₄—O], [C₃H₆—O], and/or [C₄H₈—O]units may be arranged blockwise, alternating, periodically and/or statistically; and
any of the [C₂H₄—O], [C₃H₆—O], and/or [C₄H₈—O]units can be linked to —R² and/or —O,
and
E) one or more structural units of the formula (V-a) 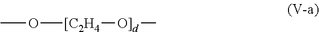
wherein
d is, based on molar average, a number from 2 to 200; and
the average number of moles of the one or more structural units of the formula (V-a) per mole of the polyester is equal to or greater than 0.3.
